(19) United States
(12) Patent Application Publication
(10) Pub. No.: US 2015/0244311 A1
(43) Pub. Date: Aug. 27, 2015

(54) Solar Generation Panel Washing Device

(71) Applicant: PROTRUST CO., LTD, Tokyo (JP)

(72) Inventor: Koichi Nakagawa, Aichi (JP)

(21) Appl. No.: 14/131,711

(22) PCT Filed: Apr. 16, 2013
(86) PCT No.: PCT/JP2013/061236

§ 371 Date: Jan. 9, 2014

(30) Foreign Application Priority Data
Jul. 17, 2012 (JP) 2012-158994

(51) Int. Cl. H02S 40/10; B08B 1/00; B08B 3/02

(52) U.S. Cl. CPC H02S 40/10; B08B 3/02; B08B 1/008

(57) ABSTRACT

A solar generation panel washing device is provided with a pair of upper and lower fixed guide rails for providing along an upper end and a lower end respectively of a solar generation panel. Also provided is a moving frame for movement in a horizontal direction over the fixed guide rails, the moving frame being provided with a pair of left and right moving guide rails over which a cleaner element is for moving in a vertical direction. Washing an entire surface of the panel is possible through the movement in a vertical direction by the cleaner element and the movement in a horizontal direction by the moving frame. Rotary motion of one of the moving guide rails is transferred into reciprocating motion of the cleaner element in the vertical direction by a non-contact power transfer mechanism of magnetic members respectively provided to the moving guide rails and the cleaner element.

### TECHNICAL FIELD

The present invention relates to a solar generation panel washing device installed on a roof or the like.

### TECHNICAL BACKGROUND

Increased environmental awareness has in recent years led to a general interest in various methods for use as clean power generation methods that do not produce exhaust gases or other such pollution. Of these, solar power generation has not only been promoted by a system of government subsidies, but is easily introduced into ordinary residences, and the numbers of households having solar generation panels installed is on the increase.

However, due to being installed outdoors, such as on top of a roof or the like, soiling (such as dust, pollen, Asian dust, or, depending on the installed location, volcanic ash or the like) gradually adheres and builds up on solar generation panels (hereinafter termed simply “panels”). Furthermore, after rainfall, the panel surface is wet, making it even easier for soiling to adhere. As long as the surface of a panel remains in a soiled state, transmittance of sunlight is reduced, leading to a marked drop in the generation efficiency of the panel. Periodic operations of washing the panel surface are necessary to ensure adequate generation levels, but the need for a person to periodically climb up onto a rooftop and perform a washing operation is not only risky, but difficult to perform, making it necessary to rely on expensive professionals for the task.

To address such issues, various cleaning devices for solar generation panels have been proposed. For example, Patent Document 1 discloses a device provided with a carriage 8 that moves across a panel installed on a roof, the carriage 8 being equipped with a cleaner element 17 for cleaning the surface of the panel. The carriage 8 has a width equal to the width of the panel. The cleaner element 17, with which the carriage 8 is equipped, cleans the panel while moving left and right across the width direction of the panel. The carriage 8 is moreover capable of being moved vertically over the panel surface. Vertical movement of the carriage 8 is brought about by a motor 16 which reels and unreels from the rooftop a wire 15 attached to the carriage 8, and guide wheels 10 provided at both left and right ends of the carriage 8 travel along a water supply pipe 4 serving as a guide rail.

### CONVENTIONAL ART LIST

### Patent Documents

Patent Document 1: Japanese Laid-open Patent Publication No. 2004-186632

### SUMMARY OF THE INVENTION

### Problems to be Solved by the Invention

The device disclosed in the aforementioned Patent Document 1 obviates the need for an operator to climb onto the roof, so that cleaning can be done easily; however, problems such as the following will occur. First, during vertical movement across the sloped surface of the roof by the carriage equipped with the cleaner element, operating noise and vibration are produced by the motor and by reeling and unreeling of the wire. Furthermore, because the wheels of the carriage move along a guide rail, in addition to noise and vibration, problems such as wear or rusting of the guide rail, entrapment of litter therein, and the like may arise. Moreover, because the carriage is supported solely by the wire, there is a danger of falling during high winds, and furthermore, the possibility of falling due to power outage must be considered as well. Moreover, being constantly exposed to the elements, the wire easily deteriorates, and its appearance suffers as well.

Furthermore, the vertically moving carriage is equipped with a motor for lateral movement of the cleaner element (brush), a motor for rotating the cleaner element, a control device, and the like, and therefore not only is the weight of the carriage greater, placing a greater load on the roof, but the need for electrical wiring and the like leading to the carriage interior and to the outside of the carriage makes the device more complex. The visible electrical wiring leading outside from the carriage is unsightly and necessitates heavy maintenance. Moreover, as the carriage covers a portion of the panel, reduced generation efficiency of the panel is a problem as well.

With a view to addressing the issues above, it is an object of the present invention to provide a washing device that minimizes vibration and operating noise during the washing operation, and that simplifies the complex configuration for electrical wiring and the like, producing an attractive appearance, and moreover affording ease of maintenance.

### Means to Solve the Problems

To attain this object, the invention according to a first aspect consists in a solar generation panel washing device including a pair of upper and lower fixed guide rails for providing along an upper end and a lower end respectively of a solar generation panel; a moving frame provided with a pair of left and right moving guide rails bridged between the pair of upper and lower fixed guide rails and for movement in a horizontal direction; a cleaner element provided to the pair of left and right moving guide rails and for movement in a vertical direction along an axial direction of the moving rails for washing; an entity surface of the solar generation panel through the movement in the vertical direction by the cleaner element and the movement in the horizontal direction by the moving frame provided with the cleaner element; a first non-contact power transfer mechanism including a plurality of driving-side magnetic members disposed at first predetermined spacings on the moving guide rail, and a driven-side magnetic member provided to the cleaner element so as to face the driving-side magnetic members across the first predetermined spacings, wherein rotary motion of one of the moving guide rails of the moving frame is arranged to be transferred into reciprocating motion of the cleaner element in the vertical direction.

The invention according to a second aspect is a second non-contact power transfer mechanism including a plurality of driving-side magnetic members provided at second predetermined spacings to a shaft-shaped member provided along one fixed guide rail from among the pair of upper and lower fixed guide rails; and a driven-side magnetic member provided to a frame linking the pair of left and right moving guide rails of the moving frame at respective first ends thereof, and positioned opposed to the driving-side magnetic members of the shaft-shaped member at the second predetermined spacings, wherein rotary motion of the shaft-shaped member is arranged to be transferred into reciprocating motion of the moving frame in the vertical direction.

The invention according to a third aspect is that in the one of the moving guide rails provided with driving-side magnetic members of the first non-contact power transfer mechanism, the outside diameter of sections provided with the driving-side magnetic members, and the outside diameter of sections not provided with the driving-side magnetic members, are equal, and the outside peripheral surface thereof is formed to a flat profile.

The invention according to a fourth aspect is that a water supply line is provided above one fixed guide rail from among the pair of upper and lower fixed guide rails and extends along the guide rail; a plurality of water supply valves are provided at third predetermined spacings to the water supply line; and a water supply port communicating with a water supply tank provided to the cleaner element is provided to the cleaner element; and the water supply port is provided at a position enabling connection to the water supply valves when the cleaner element has moved into proximity to the water supply line.

Additionally, the cleaner element is provided with a cleaning member for rotating while in contact with the panel surface as the cleaner element moves in the vertical direction; spray nozzles for spraying water from the water supply tank towards the panel surface contacting the cleaning member; and a wiper for wiping the panel surface.

A further characterizing feature is that the moving frame is provided with a first motor, the cleaner element being moved in the vertical direction through rotation about an axial center of the one of the moving guide rails by the first motor; and the cleaning member of the cleaner element rotates in association with this movement in the vertical direction. Additionally, the rotating shaft of the first motor is provided with a cylindrical-shaped magnetic member in opposition at predetermined spacing to a driving-side magnetic member at a first end side of the one of the moving guide rails, and torque of the first motor is transferred into rotational motion of the one of the moving guide rails, by a third non-contact power transfer mechanism including the magnetic member of the first motor, and the driving-side magnetic member at the first end side of the one of the moving guide rails. Furthermore, the first motor is charged by a non-contact charging device provided to the moving frame.

Additionally, the one of the fixed guide rails is provided with a second motor for rotating the cylindrical-shaped magnetic member about an axial center, the rotating shaft of the second motor being provided with a cylindrical-shaped magnetic member in opposition at predetermined spacing to the driving-side magnetic member at the first end side of the cylindrical-shaped magnetic member, and torque of the second motor is transferred into rotational motion of the shaft-shaped member by a fourth non-contact power transfer mechanism including the magnetic member of the second motor, and the driving-side magnetic member at the first end side of the shaft-shaped member.

Additionally, the fixed guide rail at the lower side is attached at a predetermined spacing away from the panel lower end, and the fixed guide rail at the upper side is attached at a predetermined spacing away from the panel upper end.

### Advantageous Effects of the Invention

According to the solar generation panel washing device disclosed in eth first aspect, the cleaner element moves in the vertical direction, while the moving frame provided with the cleaner element moves in the horizontal direction, whereby the entire panel surface can be completely cleaned in a manner free of unevenly washed areas. Additionally, due to the provision of the first non-contact power transfer mechanism for transferring rotational motion of one of the moving guide rails is into reciprocating motion of the cleaner element in the vertical direction, it is unnecessary for the vertically-moving cleaner element to have a motor for vertical movement, a control panel, or the like, thus making it lighter in weight, as well as obviating the need for electrical wiring between the cleaner element and the moving frame, affording a simpler configuration, good appearance, and ease of maintenance. Furthermore, due to the non-contact design of the non-contact power transfer mechanism, i.e., the driving-side magnetic members provided to one of the moving guide rails of the moving frame, and the driven-side magnetic members provided to the cleaner element, operating noise and vibration during vertical movement of the cleaner element (specifically, during washing operations) can be reduced, and wear of the moving guide rails or entrapment of litter therein eliminated.

Additionally, according to the solar generation panel washing device disclosed in the second aspect, a second non-contact power transfer mechanism is provided for transferring rotational motion of the shaft-shaped member into reciprocating motion of the moving frame in the horizontal direction, thereby obviating need for the horizontally-moving moving frame to itself have a motor for left and right movement, a control panel, or the like, thus making it lighter in weight, as well as obviating the need for electrical wiring between the moving frame and the shaft-shaped member, affording a simpler configuration, good appearance, and ease of maintenance. Moreover, due to the non-contact design of the non-contact power transfer mechanism, i.e., the driving-side magnetic members provided to the shaft-shaped member, and the driven-side magnetic members provided to the moving frame, operating noise and vibration during horizontal (left and right) movement of the moving frame can be reduced, and wear of the moving frame or the shaft-shaped member, or entrapment of litter therein, is eliminated.

Additionally, according to the solar generation panel washing device disclosed in the third aspect, the outside peripheral surface of the one of the moving guide rails that is provided with the driving-side magnetic members is formed to a flat profile, whereby the one of the moving guide rails functions as a drive rail provided with driving-side magnetic members for vertically moving the cleaner element, as well as functioning as a guide rail for guiding the cleaner element. By accomplishing these two functions with a single rail, weight reduction can be achieved with no loss of visual appeal.

Additionally, according to the solar generation panel washing device disclosed in the fourth aspect, a water supply line extending along a fixed guide rail is provided above one fixed guide rail of the pair of upper and lower fixed guide rails; a plurality of water supply valves are provided at predetermined spacing to the water supply line; and a water supply port communicating with a water supply tank provided to the cleaner element is provided to the cleaner element, the water supply port connecting to the water supply valves when the cleaner element has moved into proximity to the water supply line, thereby making it possible for water to be supplied from the water supply line to the water supply tank of the cleaner element. Therefore, water is supplied to and held in the water supply tank only during washing operations, and at times other than when washing operations are taking place, such as during standby or the like, the water supply tank is empty, greatly minimizing the weight load on the roof. Moreover, the need for a hose or the like to supply water from the water supply line to the cleaner element is obviated, so appearance does not suffer.

Furthermore, the cleaner element includes a cleaning member for rotating while in contact with the panel surface; a plurality of spray nozzles for spraying water from the water supply tank towards the panel surface contacting the cleaning member, and a wiper for wiping the panel surface. As the cleaner element moves in the vertical direction, the moving frame to which the cleaner element is provided moves in the horizontal direction, whereby the entire panel surface can be completely cleaned in a manner free from unevenly washed areas.

Additionally, the moving frame is provided with a first motor, making possible vertical movement of the cleaner element and rotation of the cleaning member by the first motor, thereby eliminating the need to install on the cleaner element electrical equipment, such as a motor or the like, for rotating the cleaning member, to achieve reduced weight of the cleaner element.

Furthermore, with regard to transfer of the drive force of the first motor and the second motor, because non-contact power transfer mechanisms that utilize magnetic members are employed, operating noise and vibration during movement of the cleaner element and moving frame are minimized, and the configuration is simplified, so that appearance does not suffer. Furthermore, because the first motor, which moves together with the moving frame, is charged by a non-contact charging device, it is possible for the electrical controller for the first motor, the non-contact charging device, and the like to be completely isolated by a cover or the like, so that the electrical wiring is not exposed to the outside, affording not only a good appearance, but greater safety as well.

Additionally, the fixed guide rail at the lower side is attached at a predetermined spacing away from the panel lower end, and the fixed guide rail at the upper side is attached at a predetermined spacing away from the panel upper end, thereby affording a design such that, during standby, during water supply, or the like, the cleaner element is constantly positioned between the panel and the guide rails which are spaced at predetermined spacing, so that light to the panel is not blocked by the cleaner element.

Thus, the solar generation panel washing device according to the present invention respectively employs non-contact power transfer mechanisms that rely on non-contact magnetic meshing (attractive and repulsive forces) for transfer of power at each location, whereby substantially no operating noise or vibration is produced, cleaning operations are possible at times when power is not being generated (such as at night), and panel surfaces can be periodically cleaned automatically, to thereby prevent diminished generating efficiency, and ensure the power level of the panel. Moreover, power transfer is possible even when rain, sand, litter (dead leaves or the like) become stuck in a non-contact power transfer mechanism, and the need for oiling operations or the like, which would be required for contacting rails made of metal, is obviated. Furthermore, the cleaner element and the moving frame, which move during washing operations, do not require electrical wiring, or are constituted such that electrical wiring is not exposed, and therefore maintenance is easy, and both functional and design qualities are provided.

### BRIEF DESCRIPTION OF THE DRAWINGS

FIG. 1 is an overall perspective view of a solar generation panel washing device according to the present invention;

FIG. 2 is an overall perspective view of a moving frame;

FIG. 3 is a perspective view of joined sections of a moving frame and a fixed guide rail (lower side);

FIG. 4 is a perspective view of joined sections of a moving frame and a fixed guide rail (upper side);

FIG. 5 is an enlarged fragmentary view of FIG. 4;

FIG. 6 is a perspective view of a cleaner element;

FIG. 7 is a side view of a cleaner element (in a case of descending along the panel surface);

FIG. 8 is a descriptive diagram of first and second non-contact power transfer mechanisms; and

FIG. 9 is a descriptive diagram of third and fourth non-contact power transfer mechanisms.

### DESCRIPTION OF THE EMBODIMENTS

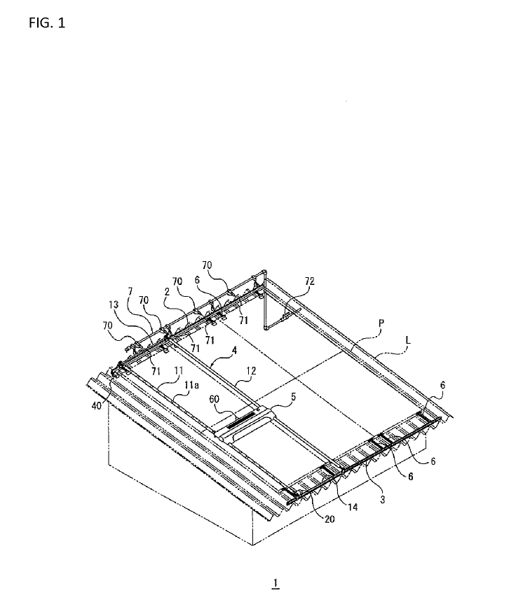

The embodiment of the solar generation panel washing device (hereinbelow termed the “washing device”) according to the present invention is described below on the basis of the drawings. The washing device is attached to a solar generation panel (hereinbelow termed a “panel”) installed on a roof. It is possible for the washing device of the present embodiment to be attached not just during installation of a panel, but to a previously installed panel as well. As shown in FIG. 1, the washing device 1 of the present embodiment is generally constituted by a pair of parallel upper and lower fixed guide rails 2, 3 respectively provided at the top and bottom of a panel P installed on a sloping roof L; a moving frame 4 attached in leftward- and rightward-moveable fashion so as to bridge between the fixed guide rails 2, 3; a cleaning element 5 provided in vertically movable fashion to the moving frame 4; and a water supply line 7 provided parallel to the fixed guide rail 2 and situated above the fixed guide rail 2 at the upper side.

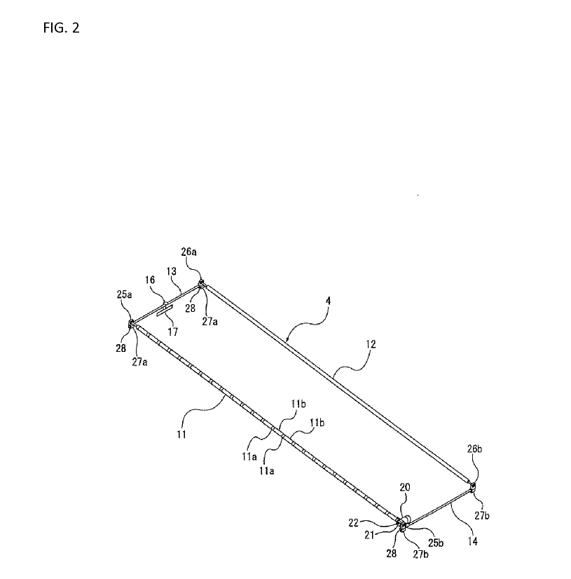

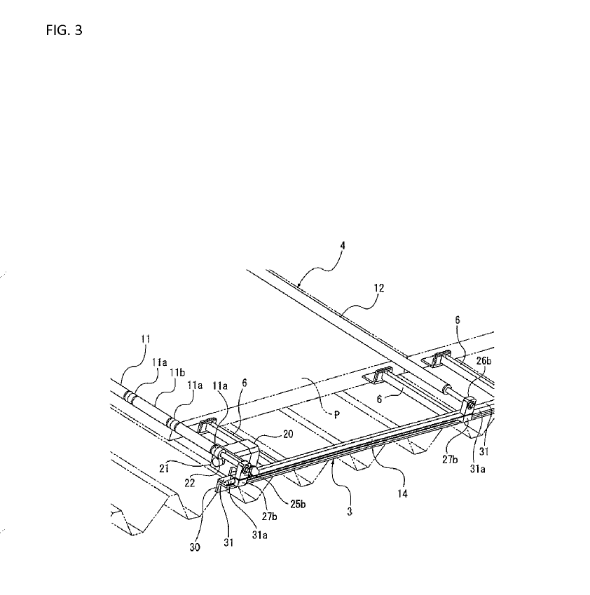

The moving frame 4 is formed to rectangular frame shape adapted to bridge over the pair of upper and lower fixed guide rails 2, 3, while oriented parallel to the sloped surface of the panel P and moveable in the left and right directions; and is constituted by a pair of left and right moving guide rails 11, 12, an upper side frame 13 linking the upper ends of the moving guide rails 11, 12, and a lower side frame 14 linking the lower ends of the moving guide rails 11, 12. As shown in more detail in perspective view in FIG. 2, the moving guide rail 11 at the left side is rotatably attached to bearing parts 25a, 25b provided on the respective left end upper surfaces of the upper side frame 13 and the lower side frame 14, while the right side moving guide rail 12 is fixed to bearing parts 26a, 26b provided on the respective right end upper surfaces of the upper side frame 13 and the lower side frame 14. Guide rail receptacles 27a, 27a are respectively provided below the bearing parts 25a, 26a at the upper side; likewise, guide rail receptacles 27b, 27b are respectively provided below the bearing parts 25b, 26b at the lower side. Recessed portions 28, 28, . . . of circular cross section adapted to mate with the fixed guide rails 2, 3 are formed in the guide rail receptacles 27a, 27a, 27b, 27b, and resin bearings are attached inside these recessed portions 28, 28, . . . . Additionally, a downward-facing, “T” shaped magnet attachment plate 16 extending parallel to the upper side frame 13 is provided at the approximate lengthwise center of the upper side frame 13, and a magnet plate 17 constituted by a magnetic member of plate form is attached to the magnet attachment plate 16 on the side thereof opposing the lower side frame 14. Furthermore, a first motor 20, constituted by a stepping motor, is provided, via an attachment member 21, to the left end of the lower side frame 14. The first motor 20 is provided with a cylindrical magnetic member 22 as shown in FIG. 3. The left side moving guide rail 11 can rotate about its axial center by this first motor 20. Cylindrical magnetic members 11a are attached at predetermined spacing to the left side moving guide rail 11, with the intervals between the cylindrical magnetic members 11a being finished to a flat surface by resin 11b, so that no steps are present on the outside peripheral surface thereof. Furthermore, cleaning element position sensors (not shown in the drawings) for detecting passage of the cleaning element 5 are embedded at predetermined spacing (for example, 50 cm) in the right side moving guide rail 12.

The pair of upper and lower fixed guide rails 2, 3 are rails of elongated shape slightly longer than the width of the panel P, attached in respectively parallel orientation at the upper end and lower end of the panel P by a plurality of panel supports 6, 6, 6, . . . . The lower side fixed guide rail 3 is attached at a parallel orientation along the panel P at predetermined spacing further to the downhill slope side from the lower end of the panel P. FIG. 3 is a perspective view of joined sections of the lower side fixed guide rail 3 and the moving frame 4. In the lower side fixed guide rail 3, a guide frame 31 is anchored onto a base frame 30 of “L” shaped cross section, and a projecting strip guide part 31a extending along the lengthwise direction from the lower side edge of the guide frame 31 projects across the entire length of the guide frame 3. The guide frame receptacles 27b, 27b of the moving frame 4 mate with this projecting strip guide part 31a, so that the moving frame 4 is slidable to the left and right directions.

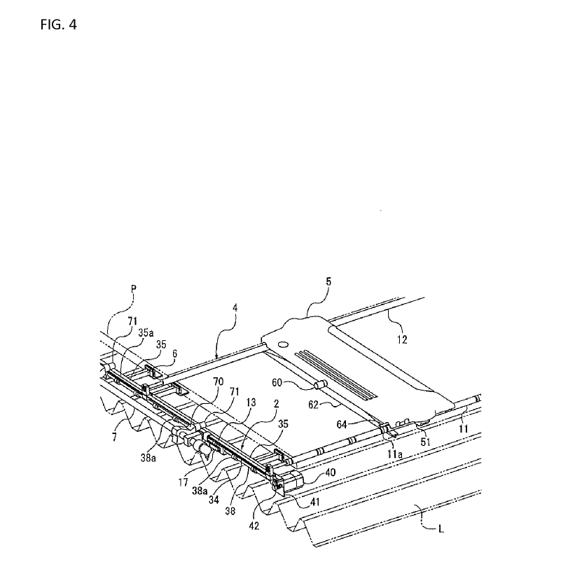

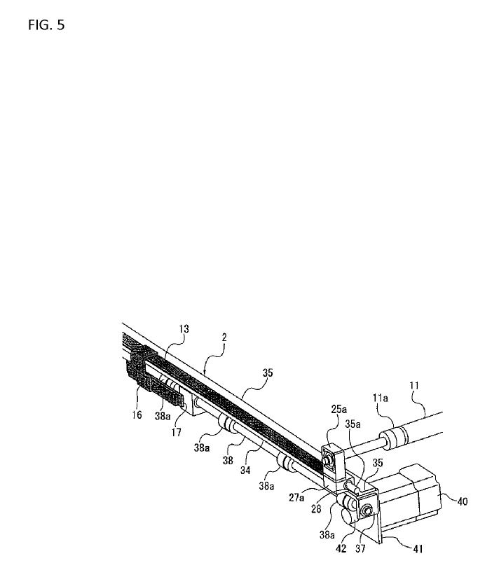

The upper side fixed guide rail 2 is attached at a parallel orientation along the panel P at predetermined spacing further to the uphill slope side from the upper end of the panel P. FIG. 4 is a perspective view of joined sections of the upper side fixed guide rail 2 and the moving frame 4, and FIG. 5 is an enlarged fragmentary view thereof (for convenience, in FIG. 5, the upper side frame 13 of the moving frame 4 is shown represented by hatching). As shown in FIG. 5, in the upper side fixed guide rail 2, a guide frame 35 is anchored onto a base frame 34 of “L” shaped cross section, and a projecting strip guide part 35a extending along the lengthwise direction from the upper side edge of the guide frame 35 projects across the entire length of the upper side fixed guide rail 2. The guide frame receptacles 27a, 27a of the moving frame 4 mate with this projecting strip guide part 31b, so that the moving frame 4 is slidable to the left and right directions. Additionally, side plates 37, 37 are respectively provided to either end of the base frame 34, and a shaft-shaped member 38 is rotatably provided between the side plates 37, 37. Cylindrical magnetic members 38a are attached at predetermined spacing about the outside periphery of the shaft-shaped member 38. The magnet plate 17 of the moving frame 4 is positioned opposed to the shaft-shaped member 38. A second motor 40, constituted by a stepping motor, is provided, via an attachment member 41, to the left end of the upper side fixed guide rail 2 (the near side in FIG. 5). The second motor 40 is provided with a cylindrical magnetic member 42, and the shaft-shaped member 38 can rotate about its axial center using this second motor 40. Moving frame position sensors (not shown in the drawings) for detecting passage of the moving frame 4 are provided at predetermined spacing (for example, 1 m) to the upper side fixed guide rail 2.

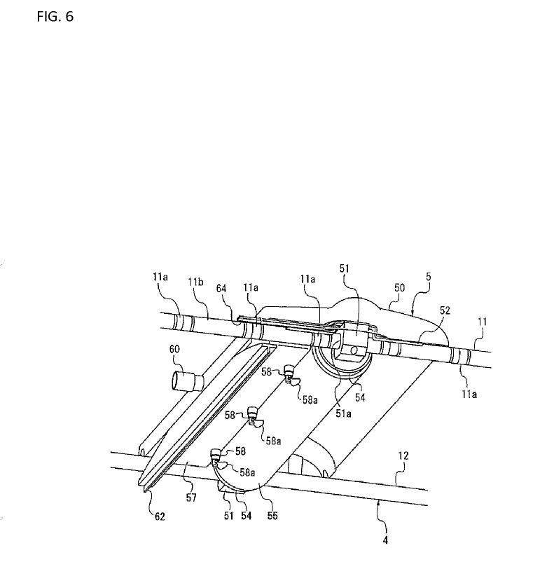

As shown in FIG. 4 and FIG. 6, the cleaning element 5 is a unit that, positioned between the pair of left and right moving guide rails 11, 12 of the moving frame 4 (more particularly, with the pair of left and right moving guide rails 11,12 inserted to pass therethrough), washes the panel P while moving in the vertical direction along the panel P surface over the moving frame 4. In FIG. 6, the left side is the uphill slope side of the sloping face of the roof L. The cleaning element 5 is provided at both the left and right ends thereof, respectively, with rail receptacles 51, in which are formed apertures 51a through which pass the inserted moving guide rails 11, 12. The insides of the apertures 51a of the rail receptacles 51, 51, specifically, the sections that contact the moving guide rails 11, 12, are respectively provided with bearings (not shown in the drawings) made of resin. Support frames 52, 52 supporting a cover 50 for covering washing components, discussed below, are respectively anchored to the rail receptacles 51, 51. The support frame 52 bends down in a downward-facing squared arch shape in side view from above the rail receptacle 51 so as to cover the front and back of the rail receptacle 51, and then bends further and extends respectively towards the front and back, parallel to the moving guide rails 11, 12. The cover 50 covers the support frames 52, 52 from above, specifically, the space between the pair of left and right moving guide rails 11, 12. A magnet plate 64, constituted by a plate-shaped magnetic member, is provided to the cleaning element 5 at a position opposed to the upper side of the surface of the left moving guide rail 11. The magnet plate 64 is greater in length than the spacing between magnetic members 11a, 11a provided to the moving guide rail 11, and is provided in a parallel orientation to the moving guide rail 11, spaced slightly away therefrom. Moreover, a rotating shaft (not shown in the drawings) is provided between the rail receptacles 51, 51, both ends of this rotating shaft being provided with a pair of rubber tires 54, 54. A roll brush 55 constituting the cleaning member is provided between the rubber tires 54, 54. The rubber tires 54, 54 and the roll brush 55 are provided on the same shaft with the rotating shaft, and rotate in unison with the rotating shaft. The diameter of the rubber tires 54 is set to a size sufficient to contact the panel P while moving over the panel P, while the diameter of the roll brush 55 is set to a size slightly larger than the diameter of the rubber tires 54. A water supply tank 57 is provided at the upward side of the sloped face of the roll brush 55. The water supply tank 57 temporarily holds water from the water supply line 7, discussed later, via a water supply port 60 provided at the center of the upper end of the cover 50. At the bottom of the water supply tank 57, a plurality of spray nozzles 58 are arrayed in the width direction of the water supply tank 57, and once the water begins to be held in the water supply tank 57, the water is sprayed from the spray nozzles 58. The spray nozzles 58 are provided at the tip with a fan-shaped spray port 58a, so that water is sprayed over the entire width of the panel P while contact is made by the roll brush 55. Furthermore, the upper end edge of the cleaner element 5 is provided with a wiper 62 facing downwards such that the lower end thereof is placed in close contact against the panel P, the width of the wiper 62 being greater than the width of the roll brush 55, and approximately the same width as the cleaner element 5.

As shown in FIG. 1, the water supply line 7 is provided above the upper side fixed guide rail 2, in a parallel orientation to the fixed guide rail 2. The basal end descends down to the ground along the wall of the building or the like, and hooks up to a water pipe via an electromagnetic on-off valve 72. Furthermore, an electromagnetic drainage valve and a drainage discharge valve or the like (not shown) are provided further ahead from the electromagnetic on-off valve 72. Additionally, the water supply line 7 is provided with a plurality of water supply nozzles 70, 70 . . . at predetermined spacing along the upper edge of the panel P, the water supply nozzles 70, 70 . . . being oriented with the tip facing towards the lower side of the sloped face, and the tip being provided with a water supply valve 71 capable of coupling to the water supply port 60 of the cleaning element 5. A valve shaft insertable by a spring is provided inside the water supply valve 71, the valve shaft inserting into the water supply valve 71 only when connected to the water supply port 60 of the cleaning element 5, whereby a valve body provided to the tip of the valve shaft opens to allow passage of water, allowing water to be supplied to the water supply tank 57 of the cleaning element 5 from the water supply line via the water supply valve 71 and the water supply port 60. The spacing of the water supply nozzles 70, 70 . . . is equal to the distance of a single cycle of lateral movement by the moving frame 4 (for example, 1 m).

A control panel (not shown) for controlling the motors, the electromagnetic valves, and so on discussed previously is provided at an arbitrary position, such as under the eaves or the like, while a controller is attached to an interior wall or the like. When the control panel receives a signal, such as a signal to initiate washing, from the indoor controller in response to a manual operation or timer setting, various types of control signals are sent to the motors, the electromagnetic valves, and so on; and control of the devices, specifically, drive control of the first motor 20 and the second motor 40, and on-off control of the electromagnetic valves, is performed. During the washing operation, the control panel, while verifying the positions of the cleaning element 5 and the moving frame 4 through position sensors provided to the upper side fixed guide rail 2 and the left side guide rail 11 of the moving frame 4, controls the first motor 20 and the second motor 40, thereby performing the washing operation by moving the cleaning element 5 longitudinally and laterally. Once the washing operation is completed, the control board performs on-off control of the electromagnetic on-off valve 72 and the electromagnetic drainage valve, and performs a drainage procedure.

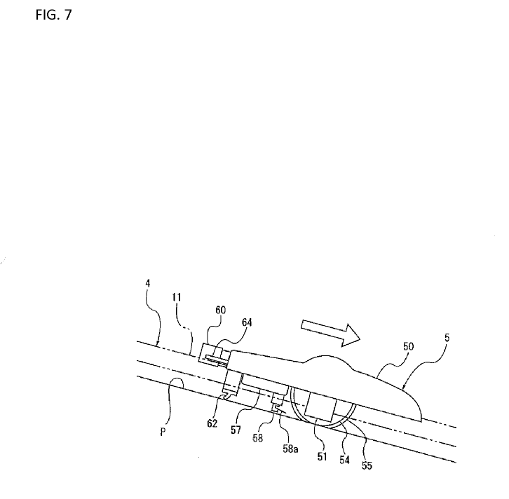

Next, the operation of washing the panel P by the washing device 1 configured in the above manner will be described. Normally, the moving frame 4 is positioned at the left end, and the cleaning element 5 is positioned at the lower end, specifically, between the lower end of the panel P and the lower side fixed guide rail 3 (hereinafter this position is termed the initial position of the cleaning element 5). Prior to the washing operation, a water supply spigot for the wash water is opened. The washing operation is then initiated manually from the indoor controller. Alternatively, washing is initiated automatically by a timer setting. Once the washing operation is initiated, the electromagnetic on-off valve 72 for the wash water opens, and the cleaning element 5 moves from the initial position to a position at the upper end of the moving frame 4. Once the cleaning element 5 moves as far as a position at the upper end of the moving frame 4, the water supply port 60 of the cleaning element 5 couples to the water supply valve 71 at the left end of the water supply line 7, and wash water is supplied from the water supply line 7 to the water supply tank 57 of the cleaning element 5, for a duration set by the timer. Once supply of water is finished, the cleaning element 5 moves downward across the moving frame 4. During this time, the panel surface is washed while the cleaning element 5 moves downward (FIG. 7). In specific terms, wash water from the water supply tank 57 is sprayed, via the spray nozzles 58, towards the panel P surface being contacted by the roll brush 55, so that soil is lifted by the roll brush 55, while removing water with the wiper 62. Then, once the cleaning element 5 has moved to the bottom end of the moving frame 4, it again moves upward while wiping up water with the wiper 62, moving to the upper end of the moving frame 4. As the cleaning element 5 moves across the panel P surface, the rubber tires 54 rotate while contacting the panel P surface, whereby rotational force is transmitted also to the roll brush 55 on the same shaft, rotating it. During vertical movement of the cleaning element 5, the roll brush comes into contact in a compacted state against the surface (FIG. 7), and the wash water is sprayed uniformly onto the panel P surface in overlapping fashion by the fan-shaped spray ports 58a, 58a . . . , so that adequate washing power is obtained, with no unevenly washed areas of the panel P. Additionally, the duration of supply of water to the water supply tank 57 described previously should be set to a duration just sufficient for water to collect in an amount equal to that sprayed during downward movement of the cleaning element 5. Furthermore, during vertical movement of the cleaning element, the cleaning element position sensors of the right side moving guide rail 12 detect the position of the cleaning element 5.

In this way, the cleaning element 5 repeats vertical movement, i.e., the washing operation, for any set number of iterations. Once the washing operation through vertical movement of the cleaning element 5 is completed, the cleaning element 5 temporarily comes to halt between the panel P lower end and the lower side fixed guide rail 3, and while at a halt, is slid to the right side by a predetermined distance, together with the moving frame 4. The predetermined distance is equal to one full width of the area that was able to be washed during the preceding vertical moving wash, e.g., 1 m. During this lateral movement of the moving frame 4, the moving frame position sensors of the upper side fixed guide frame 2 detect the position of the moving frame 4. Then, in the same manner as the vertical movement behavior discussed previously, the cleaning element 5 moves upward, and after being supplied with water, this time from the second water supply valve 71 from the left, performs the washing operation while moving vertically; when finished, the moving frame 4 again moves right. In this way, vertical movement, i.e., the washing operation, and lateral movement are repeated. Then, when the washing operation of the entire panel P has been completed, the cleaning element 5 moves back to the initial position and halts there. Finally, the electromagnetic on-off valve is closed, the drainage valve is opened and closed to drain any remaining water from the wash pipe in order to prevent freezing, and upon verification by the indoor controller that the washing operation has been completed, the operation finishes.

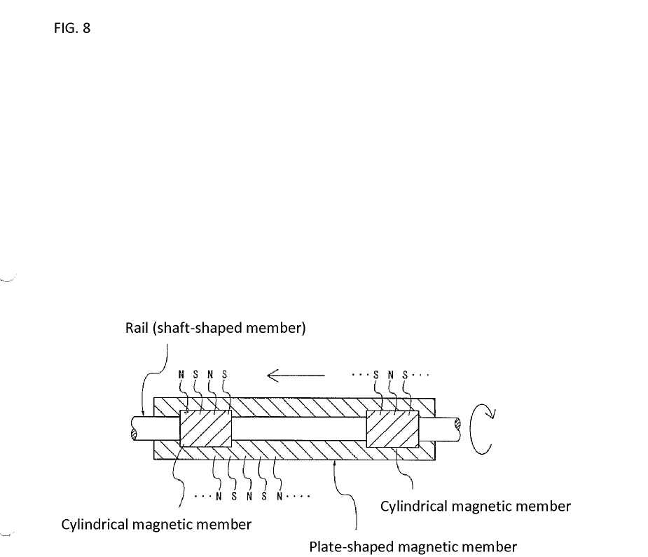

The method for producing vertical movement of the cleaning element 5 with respect to the moving frame 4 will now be described in more detail. Vertical movement of the cleaning element 5 employs a non-contact power transfer mechanism utilizing attraction and repulsion of cylindrical magnetic members 11a provided to the left side moving guide rail 11 of the moving frame, and the magnet plate 64 provided to the cleaning element 5. As shown in FIG. 8, alternating magnetic poles, i.e., N poles and S poles, respectively of helical shape (oblique shape) are provided to the plurality of cylindrical magnetic members 11a which have been provided to the left side moving guide rail 11, these N poles and S poles being positioned at equidistant intervals. Additionally, in the magnet plate 64 (plate-shaped magnetic member), alternating sloped N poles and S poles are positioned at identical intervals, in corresponding fashion to the magnetic poles of the magnetic members 11a. As the moving guide rail 11 is rotated about its axial center by the first motor 20 constituting its chive source, the magnetic poles of the magnetic members 11a are respectively superimposed. Therefore, due to the magnetic force acting between the magnetic members 11a and the magnet plate 64, the cleaning element 5 provided with the magnet plate 64 moves along the moving guide rails 11, 12 in the lengthwise direction. Additionally, when the direction of rotation of the left side guide rail 11 is reversed, the superimposition direction reverses, and therefore the direction of movement of the cleaning element 5 provided with the magnet plate 64 reverses direction as well. In this way, utilizing attraction and repulsion of magnets, power transfer from rotational motion of the left side moving guide rail 11 to vertical reciprocating movement of the cleaning element 5 (the first non-contact power transfer mechanism) is achieved. Here, the cylindrical magnetic members 11a of the left side moving guide rail 11 correspond to the driving-side magnetic members of the first aspect, and the magnet plate 64 of the cleaning element 5 to the driven-side magnetic member of the first aspect.

The method for producing left and right movement of the moving frame 4 provided with the cleaning element 5 will now be described in more detail. A non-contact power transfer mechanism like that discussed previously is employed to move the moving frame 4 as well. As shown in FIG. 8, alternating magnetic poles, i.e., N poles and S poles, respectively of helical shape are provided to the plurality of cylindrical magnetic members 38a which have been provided to the shaft-shaped member 38, these N poles and S poles being positioned at equidistant intervals. Additionally, in the magnet plate 17 (plate-shaped magnetic member) of the moving frame 4, alternating sloped N poles and S poles are positioned at identical intervals, in corresponding fashion to the magnetic poles of the magnetic members 38a. As the shaft-shaped member 38 is rotated about its axial center by the second motor 40 constituting its drive source, the magnetic poles of the magnetic members 38a are respectively superimposed. Therefore, due to the magnetic force acting between the magnetic members 38a and the magnet plate 17, the moving frame 4 provided with the magnet plate 17 moves along the shaft-shaped member 38 in the lengthwise direction. Additionally, when the direction of rotation of the shaft-shaped member 38 is reversed, the superimposition direction reverses, and therefore the direction of movement of the moving frame 4 provided with the magnet plate 17 reverses direction as well. In this way, utilizing attraction and repulsion of magnets, power transfer from rotational motion of the shaft-shaped member 38 to left and right reciprocating movement of the moving frame 4 (the second non-contact power transfer mechanism) is achieved. Here, the cylindrical magnetic members 38a of the shaft-shaped member 38 correspond to the driving-side magnetic members of the fourth aspect, and the magnet plate 17 of the moving frame 4 to the driven-side magnetic member of the fourth aspect

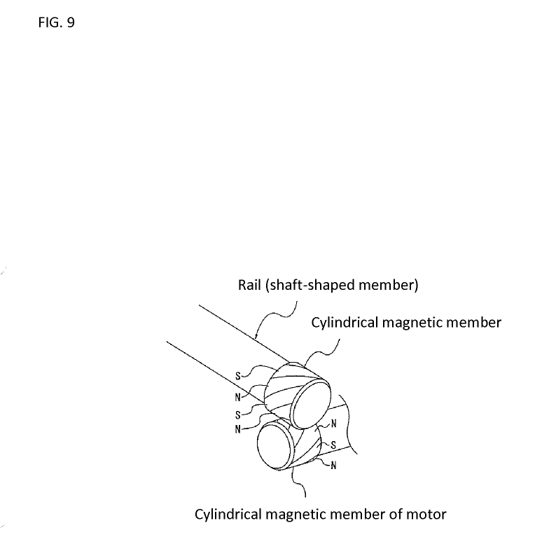

Further, transfer of torque of the first motor 20 and the second motor 40 to rotate the moving guide rail 11 and the shaft-shaped member 38 about their axial centers will now be described. The cylindrical magnetic member 22 of the first motor 20 is positioned in opposition at a right angle to and spaced apart from the magnetic member 11a situated at the lower end of the left side moving guide rail 11 (FIG. 3). As shown in FIG. 9, in the magnetic member 22 of the first motor 20, alternating N poles and S poles are arranged in a helical shape comparable to that of the magnetic member 11a of the moving guide rail 11, the spacing thereof being set to the same spacing as that of the N poles and S poles in the magnetic member 11a. As the first motor 20 rotates, specifically, as the magnetic member 22 of the first motor 20 rotates about its axial center, the magnetic poles of the magnetic member 22 are respectively superimposed, and due to the magnetic force acting between the magnetic member 22 and the magnetic member 11a, the magnetic member 11a, specifically, the left side moving guide rail 11, rotates about its axial center as well. In this way, a non-contact power transfer mechanism (third non-contact power transfer mechanism) is employed for transfer of power of the first motor 20 as well. Likewise, the cylindrical magnetic member 42 of the second motor 40 is positioned in opposition at a right angle to and spaced apart from the magnetic member 38a at the left end of the shaft-shaped member 38 (FIG. 5). As shown in FIG. 9, in the magnetic member 42 of the second motor 40, alternating N poles and S poles are arranged in a helical shape comparable to that of the magnetic member 38 of the shaft-shaped member 38, the spacing thereof being set to the same spacing as that of the N poles and S poles in the magnetic member 38a. As the second motor 40 rotates, specifically, as the magnetic member 42 of the second motor 40 rotates about its axial center, the magnetic poles of the magnetic member 42 are respectively superimposed, and due to the magnetic force acting between the magnetic member 42 and the magnetic member 38a, the magnetic member 38a, specifically, the shaft-shaped member 38, rotates about its axial center as well. In this way, a non-contact power transfer mechanism (fourth non-contact power transfer mechanism) is employed for transfer of power of the second motor 40 as well.

Through rotation of the left side moving guide rail 11 about its axial center driven by the first motor 20 in the above manner, the cleaning element 5 slides in the vertical direction; and through rotation of the shaft-shaped member 38 driven by the second motor 40, the moving frame 4 provided with the cleaning element 5 slides in the left and right directions. Consequently, reciprocating movement of the cleaning element 5 is possible in the vertical and in the left and right directions through rotation of the first motor 20 and the second motor 40, and the entire surface of the panel P can be washed. Non-contact power transfer mechanisms that utilize attraction and repulsion of magnets are employed for the respective power transfers.

Next, the method for charging the first motor 20, which moves in the left and right directions together with the moving frame 4, will be described. The first motor 20 is provided with a battery, and because charging of the battery is performed by a non-contact charging device, the electrical wiring and the like is minimized, making the device simpler. The non-contact charging device includes a remote part situated close to the first motor 20 of the moving frame 4 and connected to the battery of the first motor 20, and a base part connected to a power supply which is provided to the roof L or the like. The base part constitutes a separate element from the remote part, and is provided at a position in adjacent opposition to the remote part when the latter is at the left end of the moving frame. Non-contact power supply from the base part, which is connected to a power supply, to the remote part is performed, and charging of the battery of the first motor 20 is performed. In this way, the first motor 20 is charged by the non-contact charging device, while standing by at the initial position. During the washing operation, it is possible to charge the battery if necessary, by moving the moving frame to the left end.

A strong, lightweight material such as FRP (CFRP or the like), aluminum, or the like is used for the moving frame, the guide rails, and so on shown in the present embodiment, with consideration to not placing an excessive load on the roof when the device is installed. The washing components and the like are completely hidden by the cover 50 of the cleaning element 5, and furthermore, the adoption of non-contact power transfer mechanisms and so on eliminates the need for electrical wiring, giving the cleaning element 5 a good appearance. Additionally, highly wear-resistant polymer resins are adopted for fastening of the cleaning element 5 and the moving frame 4, and for the resin bearings in the fastened sections of the moving frame 4 and the pair of upper and lower fixed guide rails 2, 3, thus preventing wear of the members, as well as preventing entrapment of litter or the like, and minimizing noise and vibration

In the present embodiment, the use of the roll brush 55 as the cleaning member has been described, but depending on factors such as the type of soil and the like, members of other shapes, such as specialized brushes, sponges, and the like can be used instead. For example, by utilizing as the roll brush one in which each single bristle has been highly expanded to give excellent water retention, strong washing power can be obtained due to the large contact surface area with the panel P surface, as well as reducing the risk of scratching of the panel P surface. Likewise, for the wiper 62 as well, designs for dealing with Asian dust/pollen, or for dealing with accumulated snow, may be swapped out for use as appropriate. The wiper 62 is preferably made of urethane resin, which has excellent durability. Furthermore, it is possible for the wash water sprayed from the spray nozzles 58 to be changed, as appropriate, to a spray of hot water, a detergent, or the like.

Moreover, in the present embodiment, it is preferable for the first non-contact power transfer mechanism and the second non-contact power transfer mechanism to include driving-side magnetic members (cylindrical magnetic members) and driven-side magnetic members (magnet plates), the driving-side magnetic members being cylindrical in shape; however, it is sufficient for the magnetic poles on the face thereof in opposition to the magnet plate to be constantly arrayed obliquely in corresponding fashion to the N poles and S poles of the magnet plate during rotation of the driving-side magnetic member about its axial center. Furthermore, even when the magnetic member 22 of the first motor 20 constituting the third non-contact power transfer mechanism is disk shaped rather than cylindrical, power transfer in like fashion is possible. In this case, the disk-shaped magnetic member attached to the first motor 20 would be opposed to the magnetic member 11a at the lower end (or upper end) of the left side moving guide rail 11 for transferring power, and the alternating N poles and S poles would be arrayed radially so as to correspond to the helically arrayed N poles and S poles of the magnetic member 11a. Likewise, even when the magnetic member 42 of the second motor 40 constituting the fourth non-contact power transfer mechanism is disk shaped rather than cylindrical, power transfer in like fashion is possible. In this case, the disk-shaped magnetic member attached to the second motor 40 would be opposed to the magnetic member 38a at the left end (or right end) of the shaft-shaped member 38 for transferring power, and the alternating N poles and S poles would be arrayed radially so as to correspond to the helically arrayed N poles and S poles of the magnetic member 38a.

In the washing device of the present invention, verification of replacement times for the various components mentioned above, and verification of operating conditions, can be performed from the monitor of the indoor controller. It is furthermore possible to select the wash type, the washing operation, and the like from the indoor controller. It is moreover possible to make settings to initiate washing automatically in cases in which soil-detecting sensors have been provided and soil has been detected, or in cases of a drop in generating efficiency, and to automatically wash the panel surface on an ongoing basis, to prevent a drop in the generating efficiency.

### KEY

P: solar generation panel
1: washing device
2: fixed guide rail (upper)
3: fixed guide rail (lower)
4: moving frame
5: cleaning element
7: water supply line
11: moving guide rail (left)
11a: cylindrical magnetic member (driving-side magnetic member of first non-contact power transfer mechanism)
12: moving guide rail (right)
17: magnet plate (driven-side magnetic member of second non-contact power transfer mechanism)
20: stepping motor (first motor)
38: shaft-shaped member
38a: cylindrical magnetic member (driving-side magnetic member of second non-contact power transfer mechanism)
40: stepping motor (second motor)
55: roll brush (cleaning member)
57: water supply tank
58: spray nozzle
60: water supply port
62: wiper
64: magnet plate (first non-contact power transfer mechanism: driven-side magnetic member)
71: water supply valve

1. A solar generation panel washing device washing device, comprising;
a pair of upper and lower fixed guide rails for providing along an upper end and a lower end respectively of a solar generation panel;
a moving frame provided with a pair of left and right moving guide rails bridged between the pair of upper and lower fixed guide rails and for movement in a horizontal direction;
a cleaner element provided to the pair of left and right moving guide rails and for movement in a vertical direction along an axial direction of the moving rails for washing an entire surface of the solar generation panel through the movement in the vertical direction by the cleaner element and the movement in the horizontal direction by the moving frame provided with the cleaner element and
a first non-contact power transfer mechanism including:
a plurality of driving-side magnetic members disposed at first predetermined spacings on the moving guide rail, and
a driven-side magnetic member provided to the cleaner element so as to face the driving-side magnetic members across the first predetermined spacings,
wherein rotary motion of one of the moving guide rails of the moving frame is arranged to be transferred into reciprocating motion of the cleaner element in the vertical direction.

2. The solar generation panel washing device according to claim 1, further comprising:
a second non-contact power transfer mechanism including;
a plurality of driving-side magnetic members provided at second predetermined spacings to a shaft-shaped member provided along one fixed guide rail from among the pair of upper and lower fixed guide rails; and
a driven-side magnetic member provided to a frame linking the pair of left and right moving guide rails of the moving frame at respective first ends thereof, and positioned opposed to the driving-side magnetic members of the shaft-shaped member at the second predetermined spacings,
wherein rotary motion of the shaft-shaped member is arranged to be transferred into reciprocating motion of the moving frame in the vertical direction.

3. The solar generation panel washing device according to claim 1,
wherein in the one of the moving guide rails provided with driving-side magnetic members of the first non-contact power transfer mechanism, the outside diameter of sections provided with the driving-side magnetic members and the outside diameter of sections not provided with the driving-side magnetic members are equal, and the outside peripheral surface thereof is formed to a flat profile.

4. The solar generation panel washing device according to Claim 1,
wherein a water supply line is provided above one fixed guide rail from among the pair of upper and lower fixed guide rails and extends along the guide rail;
a plurality of water supply valves is provided at third predetermined spacings to the water supply line;
a water supply port communicating with a water supply tank provided to the cleaner element is provided to the cleaner element; and
the water supply port is provided at a position enabling connection to the water supply valves when the cleaner element has moved into proximity to the water supply line.

5. The solar generation panel washing device according to claim 2,
wherein in the one of the moving guide rails provided with driving-side magnetic members of the first non-contact power transfer mechanism, the outside diameter of sections provided with the driving-side magnetic members and the outside diameter of sections not provided with the driving-side magnetic members are equal, and the outside peripheral surface thereof is formed to a flat profile.

6. The solar generation panel washing device according to claim 2,
wherein a water supply line is provided above one fixed guide rail from among the pair of upper and lower fixed guide rails and extends along the guide rail;
a plurality of water supply valves is provided at third predetermined spacings to the water supply line;
a water supply port communicating with a water supply tank provided to the cleaner element is provided to the cleaner element; and
the water supply port is provided at a position enabling connection to the water supply valves when the cleaner element has moved into proximity to the water supply line.

7. The solar generation panel washing device according to claim 3,
wherein a water supply line is provided above one fixed guide rail from among the pair of upper and lower fixed guide rails and extends along the guide rail;
a plurality of water supply valves is provided at third predetermined spacings to the water supply line;
a water supply port communicating with a water supply tank provided to the cleaner element is provided to the cleaner element; and
the water supply port is provided at a position enabling connection to the water supply valves when the cleaner element has moved into proximity to the water supply line.
